(19) United States
(12) Patent Application Publication
(10) Pub. No.: US 2017/0085149 A1
(43) Pub. Date: Mar. 23, 2017

(54) BASIC HOUSING FOR A WHEEL HUB MOTOR AND WHEEL HUB MOTOR HAVING A BASIC HOUSING

(71) Applicant: Schaeffler Technologies AG & Co. KG, Herzogenaurach (DE)

(72) Inventors: Juergen Osterlaenger, Emskirchen (DE); Tobias Vogler, Herzogenaurach (DE); Mark Lauger, Goessweinstein (DE); Raphael Fischer, Herzogenaurach (DE); Yuan Yao, Hagenbuechach (DE)

(21) Appl. No.: 15/311,431

(22) PCT Filed: Apr. 28, 2015
(86) PCT No.: PCT/DE2015/200283

§ 371 Date: Nov. 15, 2016

(30) Foreign Application Priority Data
May 15, 2014 (DE) 10 2014 209 176.4

(51) Int. Cl. H02K 5/20; H02K 7/14; H02K 5/02

(52) U.S. Cl. CPC H02K 5/20; H02K 5/02; H02K 7/14

(57) ABSTRACT

A basic housing for a wheel hub motor, which can be produced cost-effectively even in large quantities is provided. To this end, a basic housing (5) for a wheel hub motor (2) is proposed, wherein the basic housing (5) has a receiving area (14) for a stator (6), having at least one stator housing section (11) for arranging the stator (6), wherein cooling channels (15) for cooling the stator (6) are arranged in the stator housing section (11), and having a cooling device (26), wherein the cooling device (26) forms the cooling channels (15), wherein the stator housing section (11) is made of a plastics material, and wherein the cooling device (26) is at least partially embedded as a first insert in the plastics material in the stator housing section (11).

The present invention relates to a basic housing for a wheel hub motor, wherein the basic housing has a receiving area for a stator, having at least one stator housing section for situating the stator, cooling channels for cooling the stator being situated in the stator housing section, and a wheel hub motor having this basic housing.

### BACKGROUND

In electric vehicles, i.e., vehicles which are driven via an electric motor, in addition to centrally situated electric motors, which supply, for example, two wheels of a driven axle with a drive torque via a transmission, the concept of the wheel hub motor has also become established, the electric motor being installed directly on or in the wheel.

One example of such a wheel hub motor is found in document DE 20 2011 108 560 Ul. It relates to a wheel hub motor which has a motor receiving body and a rim body, the rim body being mounted so it is rotatable in relation to the motor receiving body and being able to be driven by a motor. The motor receiving body and/or the rim body may essentially be manufactured from and/or include a fiber-plastic composite.

Document DE 10 2011 081 503 B4, which represents the most proximate related art, describes a wheel hub drive system having an electric motor which may be situated inside a rim. The stator of the electric motor is connected to a stationary housing section of the wheel hub drive system. A ring-shaped cooling element having cooling channels, to which a coolant liquid, in particular water or a water-glycol mixture, is applied, is located on the radial outside of the stator. The cooling element is designed as a sleeve, on the radial outer side of which the cooling structures are introduced and which are sealed closed using a second sleeve.

### SUMMARY OF THE INVENTION

It is an object of the present invention to provide a basic housing for a wheel hub motor, which may also be mass manufactured cost-effectively.

In the scope of the present invention, a basic housing is provided which is suitable and/or designed for a wheel hub motor of a vehicle. The vehicle may be a passenger automobile, for example. Alternatively, however, it may also be provided that the vehicle is designed as a three-wheeled or two-wheeled vehicle, in particular as a motorcycle. The vehicle has at least one wheel hub motor, the wheel hub motor replacing a conventional wheel of the vehicle. The vehicle may have multiple such wheel hub motors, in particular the vehicle has two wheel hub motors on one axle.

The basic housing is situated in a frame-fixed and/or stationary way in relation to the vehicle in operation and forms a bearing partner to the tire of the wheel, which rotates in operation. The basic housing and/or the wheel hub motor defines a main axis of rotation, about which the wheel rotates.

The basic housing has a receiving area for a stator. The stator is part of an electric motor for the wheel hub motor and therefore participates in generating the drive torque of the wheel hub motor. In particular, the electric motor is designed as a permanently-excited synchronous motor.

The basic housing includes a stator housing section for situating the stator. Cooling channels for cooling the stator are situated in the stator housing section. The stator housing section particularly preferably forms a stator receiving area or delimits it in a radial direction in relation to the main axis of rotation. In particular, the stator housing section provides a cylinder jacket surface, which is situated coaxially and/or concentrically in relation to the main axis of rotation. The cylinder jacket surface forms a radial contact surface for the stator. In particular, the cooling channels form a cooling jacket for the stator.

In the scope of the present invention, it is provided that the basic housing includes a cooling device, which forms the cooling channels. The stator housing section is formed from a plastic, it being provided that the cooling device is at least sectionally embedded in the plastic as a first insert in the stator housing section. The cooling device is therefore formed as a separate component, which is embedded in the plastic of the stator housing section. In particular, the cooling device is embedded in the plastic as the first insert during a primary molding process or a shaping process of the stator housing section.

It is one consideration of the present invention that the introduction of cooling channels is complex in manufacturing if they are introduced, for example, into a material by a severing method. On the other hand, it is very simple to produce a separate cooling device, which has an arbitrary shape, because all available manufacturing technologies may be used for this purpose. Therefore, it is provided in the scope of the present invention that the cooling device be designed as a first insert, because it may be manufactured as a functional module with the aid of any arbitrary manufacturing technology in a simple and/or coolant-tight way.

The cooling device is subsequently embedded in the plastic to form the stator housing section. This procedure has the advantage that the stator housing section is weight-optimized as a result of the plastic used and additionally may be manufactured cost-effectively because of the use of plastic as a material. Therefore, it is achieved by the present invention that embedding the cooling function into the basic housing, it is suitable for mass production, may be manufactured cost-effectively, is mass-optimized and/or weight-optimized, and may be optimized to the installation space.

In one preferred implementation of the present invention, the stator housing section is designed as a plastic injection molded part section, the cooling device being extruded into, around, or onto the plastic injection molded part section as the first insert. Plastic injection molding is a process suitable for mass production, which combines short cycle times with low manufacturing costs and good functional properties of the final product.

In one preferred structural embodiment of the present invention, the cooling device has a cooling jacket section. In particular, the cooling jacket section is designed as a closed ring shape or as a hollow-cylindrical shape. The stator housing section includes an annular wall section and is formed in particular as an annular wall. The annular wall section has a delimitation surface facing toward the stator, wherein the delimitation surface is designed as a cylinder jacket surface, which is aligned coaxially and concentrically in relation to the main axis of rotation. In particular the annular wall section, and in particular the annular wall, has a hollow cylindrical shape. The delimitation surface of the stator housing section facing away from the stator may also be implemented as desired, however. The cooling jacket section is situated in the annular wall section, in particular in the annular wall. In this embodiment, the stator may be cooled over the complete width of the stator housing section and/or the cooling jacket section, without requiring a large installation space.

In one preferred refinement of the present invention, the cooling jacket section rests exposed or open on a side facing toward the stator, so that it forms a part of the contact surface for the stator. Because the thermal conductivity of plastic is limited, it may be ensured in this way that the thermal contact between the cooling device and the stator is improved. The cooling device, in particular the cooling jacket section, may also be made, for example, of plastic, glass, ceramic components, or -particularly preferably in this embodiment—a metallic material, which has particularly good thermal conductivity.

In one preferred refinement of the present invention, the cooling jacket section is designed as a cooling coil section having cooling coils. The cooling coils are implemented in particular as pipes or lines. For example, the cooling coils are wound in a spiral circumferentially around the main axis of rotation or extend in a meandering shape in the axial direction. In the preferred embodiment, it is provided that the cooling coils are flattened in a cross section, which is perpendicular to the longitudinal extension of the cooling coils and/or perpendicular to a flow direction of the coolant in the cooling coils, on the side facing toward the stator. Due to the flattening, the surface component of the cooling jacket section on the contact surface of the stator housing section for the stator is increased, so that the thermal conductivity is improved. Alternatively thereto, the cooling jacket section may be designed having a coolant conducting structure, the cooling channels being connected to one another in a network.

In another embodiment of the present invention, it is ensured that the contact surface of the stator housing section facing toward the stator is made entirely from plastic over the entire area, so that a plastic area remains between the cooling device, in particular the cooling jacket section, and the contact surface. In this embodiment, the surface contact between stator and stator housing section is not interrupted by insulating air areas, which may result as inhomogeneities in the transition area between the cooling device and the plastic of the stator housing section. To make this plastic area particularly thermally conductive, a particularly thermally-conductive plastic may optionally be used for the stator housing section. It is also possible that the stator housing section includes two plastic components, the plastic area between the cooling jacket section and the stator being made of a plastic which has a better thermal conductivity than the remainder of the plastic.

To avoid insulating air areas between the contact surface of the stator housing section and the stator due to incomplete introduction of the plastic, in particular incomplete injection of the plastic, it is provided that the cooling coils taper conically and/or to a point in the mentioned cross section in the direction of the contact surface, to facilitate the extrusion coating and/or the flowing together of the plastic in the plastic area. This embodiment is based on the consideration that, for reasons of manufacturing technology, the plastic flows from a greater wall thickness to a lesser wall thickness.

In another alternative of the present invention, a coupling layer made of a heat-conductive material, in particular plastic, is introduced between the stator carrier section and the stator, which, on the one hand, implements the mechanical securing of the stator on the stator carrier section and, on the other hand, implements improved thermal coupling between stator and stator housing section.

In one possible refinement of the present invention, the housing includes a stator carrier section which is connected to the stator housing section. The stator carrier section delimits a stator receiving area, which is formed by the stator housing section, in an axial direction in relation to the main axis of rotation. The stator carrier section is formed on the stator housing section. On the one hand, it may be provided that the basic housing has a second insert, which is embedded in the same plastic as the cooling device and which is formed as a metal part, for example, which implements the mechanical stability of the stator carrier section. Alternatively thereto, the stator carrier section may also be made exclusively of plastic, so that the basic housing may be manufactured particularly cost-effectively. In particular, the stator carrier section and the stator housing section are produced in one piece in a single manufacturing step by plastic injection molding.

In one refinement of the present invention, the basic housing includes an electronics receiving section for accommodating power electronics and/or control units and/or inverter devices for inverting a direct current from the vehicle into an alternating current for the electric motor. The electronics receiving section is situated on the stator carrier section, but is preferably positioned on a side facing away from the stator housing section. Therefore, the stator carrier section forms a partition wall between the stator housing section and the electronics receiving section. The electronics receiving section is formed on the stator housing section and/or on the stator carrier section. The electronics receiving section may also be produced by the same plastic, in particular by the same plastic injection molding method step, as the stator housing section and/or the stator carrier section. It is particularly preferably provided that the electronics receiving section, the stator housing section, and the stator carrier section are formed in one piece and are produced as a single plastic part.

In advantageous refinements of the present invention, the cooling device has further cooling sections, which extend through the electronics receiving section and/or through the stator carrier section, and which cool the mentioned sections using coolant. This refinement has the advantage that the cooling device may be extrusion coated as the first insert, for example, in a single plastic injection molding method step, to form the basic housing including the stator housing section and optionally in addition the stator carrier section and/or the electronics receiving section and to form an integrated cooling for them. Alternatively or additionally, it may be provided that the cooling device is formed as the winding heads.

In one possible refinement of the present invention, the basic housing includes the stator, the stator being formed as a further insert, which is embedded in the plastic. In particular, the stator is embedded in the plastic by the same plastic injection molding method step. This embodiment has the advantage that the relative position between stator and the stator housing section is fixed in an integrally joined way by the plastic. Optionally, the electronics of the wheel hub motor, in particular the power electronics and/or the control units and/or the inverter devices, may additionally be designed as a next insert, which is embedded in the plastic. In particular, the electronics including the interconnection and the winding heads and the stator may be designed as a further insert, which ensures the torque support of the stator without a gap and robustly via a friction-locked and/or formfitting connection.

In one preferred refinement of the present invention, the stator housing section is designed as an outer housing section of the basic housing. In particular, mechanical interfaces may be situated on the stator housing section for fastening the basic housing to the vehicle. It is possible in this case that the interfaces are designed as plastic interfaces or that further fastening devices are embedded in the plastic. Optionally, mechanical interfaces may also additionally be formed in the stator carrier section and/or in the electronic housing section. In particular, advantages with respect to the corrosion behavior may be achieved in this refinement. Furthermore, it is possible to injection mold stiffening ribs or structures on the stator housing section or on the plastic part, to stabilize the composite and therefore make it lower-noise.

Another object of the present invention relates to a wheel hub motor for a vehicle, which has a basic housing as recited in one of the preceding claims. The wheel hub motor is particularly preferably designed as an internal rotor motor, the stator being situated in the radial interior of the stator housing section. Furthermore, the wheel hub motor has a rotor, the rotor being non-rotatably connected to a rim section of the wheel hub motor, a tire of the wheel being able to be situated on the rim.

In one preferred refinement of the present invention, the basic housing, in particular the stator carrier section, has a mechanical interface for fastening a brake back plate. Alternatively or additionally, the wheel hub motor includes an integrated brake device, which may be designed as a brake drum or brake disk device. In this case, the brake linings are situated on the brake back plate, which is non-rotatably connected via the mechanical interface to the basic housing. In contrast, the brake drum or the brake disk, respectively, is non-rotatably connected to the rotor.

### BRIEF DESCRIPTION OF THE DRAWINGS

Further features, advantages, and effects of the present invention result from the following description of preferred exemplary embodiments of the present invention.

FIG. 1 shows a longitudinal sectional view of a wheel hub motor as an exemplary embodiment of the present invention;

FIG. 2 shows a basic housing of the wheel hub motor in FIG. 1 in a longitudinal sectional view in a first variant;

FIG. 3 shows the cooling device in FIG. 2 in a schematic three-dimensional view in a first variant;

FIG. 4 shows the cooling device in FIG. 2 in a schematic three-dimensional view in a second variant;

FIG. 5 shows the cooling device in FIG. 2 in a schematic three-dimensional view in a third variant;

FIG. 6 shows a basic housing of the wheel hub motor in FIG. 1 in a longitudinal sectional view in a second variant;

FIG. 7 shows a basic housing of the wheel hub motor in FIG. 1 in a longitudinal sectional illustration in a third variant;

FIG. 8 shows a schematic view of a cooling coil of the cooling devices in FIGS. 3, 4, and 5.

### DETAILED DESCRIPTION

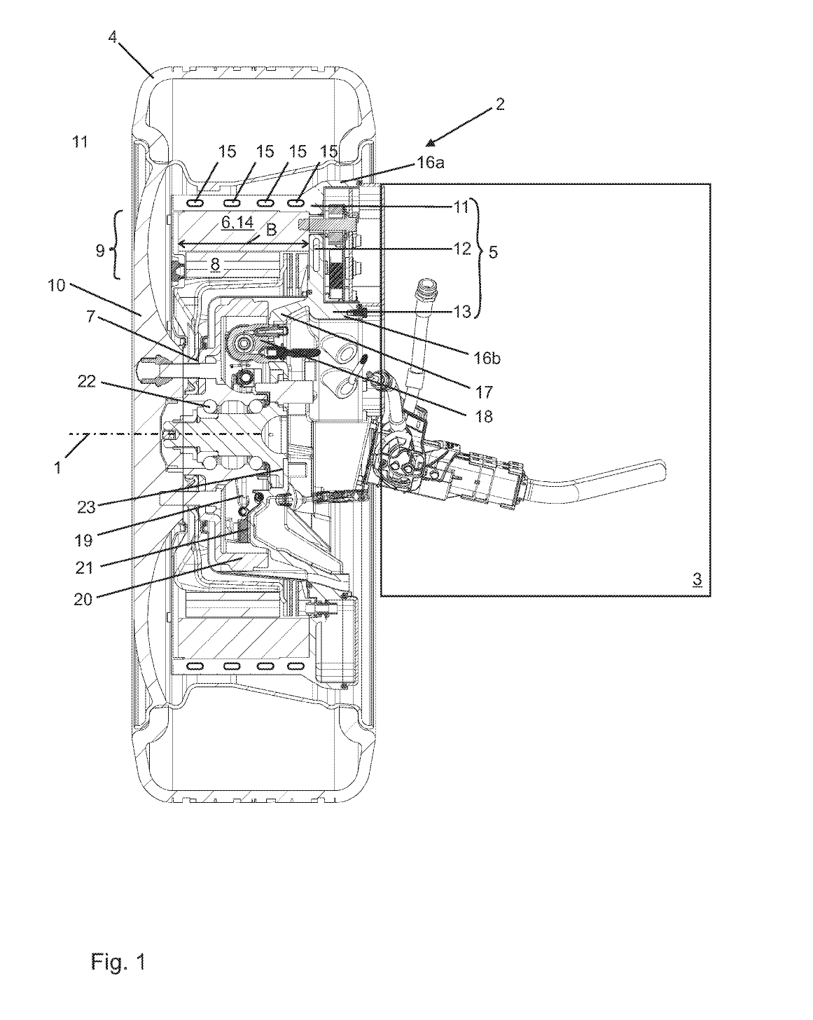

FIG. 1 shows a longitudinal sectional view along a main axis 1 of a wheel hub motor 2—also called a wheel hub system—for a vehicle 3. The vehicle may be, for example, a passenger automobile, a wheel hub motor being situated on each of the two wheels of a driven axle. It is also possible, to implement a four-wheel-drive of a vehicle 3 by forming each of the wheels as a wheel hub motor 2. Implementations in the form of a tricycle or a motorcycle are also possible, only one driven wheel being provided with wheel hub motor 2 in each case. Wheel hub motor 2 is optionally completely or at least sectionally situated in the radial interior of a tire 4.

Wheel hub motor 2 has a basic housing 5, which is situated in a frame-fixed or stationary way on vehicle 3. Basic housing 5 carries a stator 6. Furthermore, wheel hub motor 2 has a rotor carrier 7, which carries a rotor 8. Stator 6 and rotor 8 jointly form an electric motor 9, which is designed as an internal rotor. Stator 6 is designed in the form of a hollow cylinder, which revolves around main axis 1 and is situated coaxially thereto. Rotor 8 is also designed as a hollow cylinder and is situated concentrically and coaxially in relation to stator 6. Rotor carrier 7 is non-rotatably connected to rotor 8 and rotates in operation in relation to stator 6 and therefore in relation to basic housing 5. Rotor carrier 7 is connected via a rim section 10 to tire 4, so that an electrical drive torque of electric motor section 9, which is generated with the aid of stator 6 and rotor 8, may be transmitted via rotor carrier 7 and rim section 10 to tire 4, to drive vehicle 3. Stator 6 and rotor 8 are situated inside rim section 10 when viewed in the axial direction in relation to main axis of rotation 1 and do not protrude axially beyond it and/or beyond tire 4.

Basic housing 5 may be divided into three sections, namely a stator housing section 11, a stator carrier section 12, and an electronics receiving section 13. Stator housing section 11 is designed as a tubular or hollow-cylindrical section and encompasses main axis 1 completely in the circumferential direction. Stator housing section 11 is situated coaxially in relation to main axis 1 and to stator 6. Stator 6 presses flatly against its inner circumferential wall or inner wall 25, which is designed as a cylinder jacket surface, so that a heat transfer may take place from stator 6 to stator housing section 11. Alternatively, one or more thermal coupling layers are situated between stator 6 and inner wall 25. For example, stator 6 is located in an interior 14, which is formed by stator housing section 11 on the radial interior of stator housing section 11, in a press-fit in relation to inner wall 25.

To dissipate the heat generated by electric motor section 9, stator housing section 11 has cooling channels 15, which extend, for example, at least sectionally in the circumferential direction around main axis 1 and are situated in multiple rows one over another in the axial direction in this example. With respect to a width B of stator 6 in the axial direction in relation to main axis 1, at least 80% of width B is taken by cooling channels 15.

Stator housing section 11 is attached to stator carrier section 12, which extends in a radial plane in relation to main axis 1 and/or carries stator housing section 11 and bridges the installation space in the direction of main axis 1 as a disk section.

Electronics receiving section 13, which—as results in particular from the following figures—is designed as one or more receiving structures, in which the power electronics and/or the control electronics and/or inverter devices are situated in completely assembled wheel hub motor 2, is situated on the side of stator carrier section 12 facing away from stator housing section 11. Electronics receiving section 13 is delimited on the bottom side by stator carrier section 12 or by a separate bottom of its own and has side walls 16a, b extending in the axial direction on the edges.

A back plate interface 17 for an integrated brake device 18 is situated, in particular formed, on basic housing 5. Back plate interface 17 is designed as a planar plate area in a radial plane in relation to main axis of rotation 1, into which two receiving openings for fastening elements such as pins are introduced. A brake cylinder as brake device 18, which presses brake shoes 19 outward in the radial direction against a brake drum 20 connected to rotor carrier 7, may be situated on back plate interface 17. Furthermore, basic housing 5, in particular stator carrier section 12, may have at least one mechanical support point 21, which is designed for the sliding support of brake shoes 19. Mechanical support point 21 is formed as a further planar plate area in a further radial plane in relation to main axis of rotation 1. Mechanical support point 21 is optionally provided with a wear protection layer.

To enable a relative rotation between rotor carrier 7 and basic housing 5, a wheel bearing 22 is provided, which is non-rotatably connected to basic housing 5 as a first bearing partner, on the one hand, and is non-rotatably connected to rotor carrier 7 as the other bearing partner, on the other hand. Basic housing 5 or stator carrier section 12 has a corresponding bearing interface 23. With respect to bearing interface 23, it is possible, on the one hand, that it is integrally incorporated, in particular formed in stator carrier section 12. Alternatively, it is possible that stator carrier section 12 is connected to a separate bearing plate (not shown), which carries bearing interface 23.

Basic housing 5 is designed as a multifunctional body. In the exemplary embodiment of the present invention shown in FIG. 1, basic housing 5 is designed as a plastic housing. It may be provided that only stator housing section 11 is designed as a plastic part, but the manufacturing is simplified if stator housing section 11 and stator carrier section 12 or even optionally electronics receiving section 13 in addition are manufactured as a single plastic part. In this case, basic housing 5 may be produced in the scope of a plastic injection molding method in a single method step, for example.

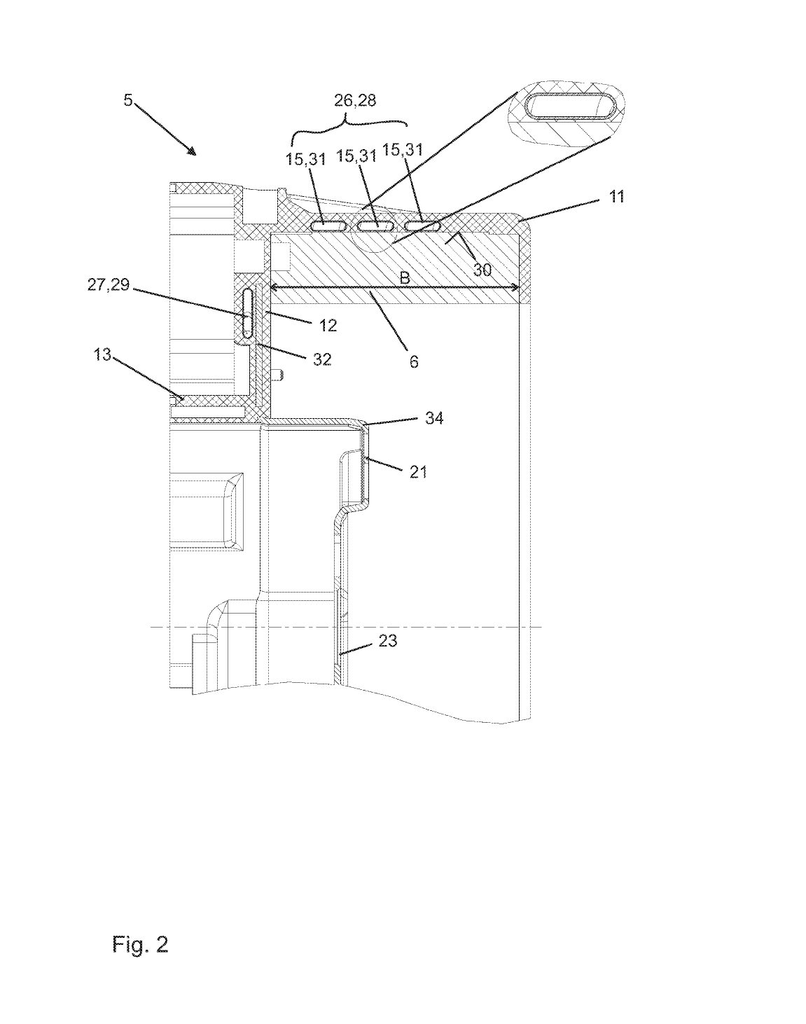

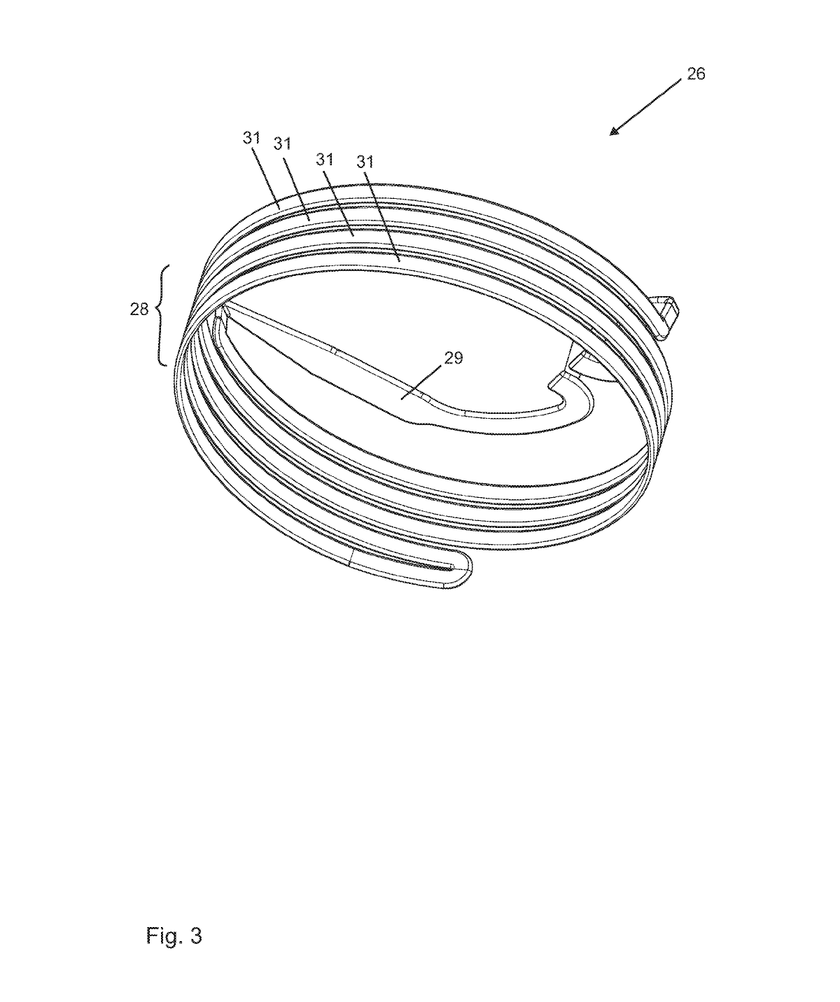

FIG. 2 shows one possible design embodiment of basic housing 5 in FIG. 1. It may be seen in the cross section shown that stator housing section 11 assumes a hollow-cylindrical shape, cooling channels 15 being situated in rows in an axial extension direction in the longitudinal section shown. Stator housing section 11, stator carrier section 12, and electronics receiving section 13 are formed as a one-piece plastic part. Cooling channels 15 are implemented by a cooling device 26, which is embedded in basic housing 5 designed as a plastic part. Cooling device 26 is also coolant-tight even without the plastic part. Examples of cooling device 26 are described by way of example in FIGS. 3, 4, and 5.

It is one concept of this implementation that the introduction of cooling channels 15 into the plastic part requires substantial expenditure. For this reason, in the present case an independent cooling device 26 is used, which is embedded as a separate and solely functional component in the plastic. In this way, on the one hand, the advantage of the cost-effective manufacturing of basic housing 5 designed as a plastic part and, on the other hand, a cost-effective implementation of cooling channels 15 may be achieved.

Cooling device 26 forms a further cooling channel 27, which extends inside stator carrier section 12 and which cools electronics receiving section 13. Cooling device 26 may have, for example, a cooling jacket section 28, which is embedded in stator housing section 11, and may have an inflow or outflow area 29, which implements further cooling channel 27. Stator 6 presses flatly with its radial outer surface in the form of a cylinder jacket on a contact surface 30 formed by stator housing section 11, so that a heat transfer is promoted between stator 6 and cooling device 26.

In the exemplary embodiment shown in FIG. 2, stator 6 is embedded as a further insert in the plastic. In particular, cooling device 26 and stator 6 are jointly extrusion coated by the plastic. This embodiment has the advantage that stator 6, being embedded in the plastic, in particular by extrusion coating using the plastic, is fixed in its position.

Cooling channels 15 or the cooling coils of cooling jacket section 28 have an oval cross section, one side of the cooling coils facing toward stator 6 being flattened. The heat transfer between stator 6 and cooling device 26 is improved by the surface enlargement as a result of the flattening. In the exemplary embodiment shown in FIG. 2, it may be provided that cooling coils 31 rest in direct contact against stator 6 or are separated therefrom by a thin intermediate layer made of plastic or a plastic area, but are thermally coupled.

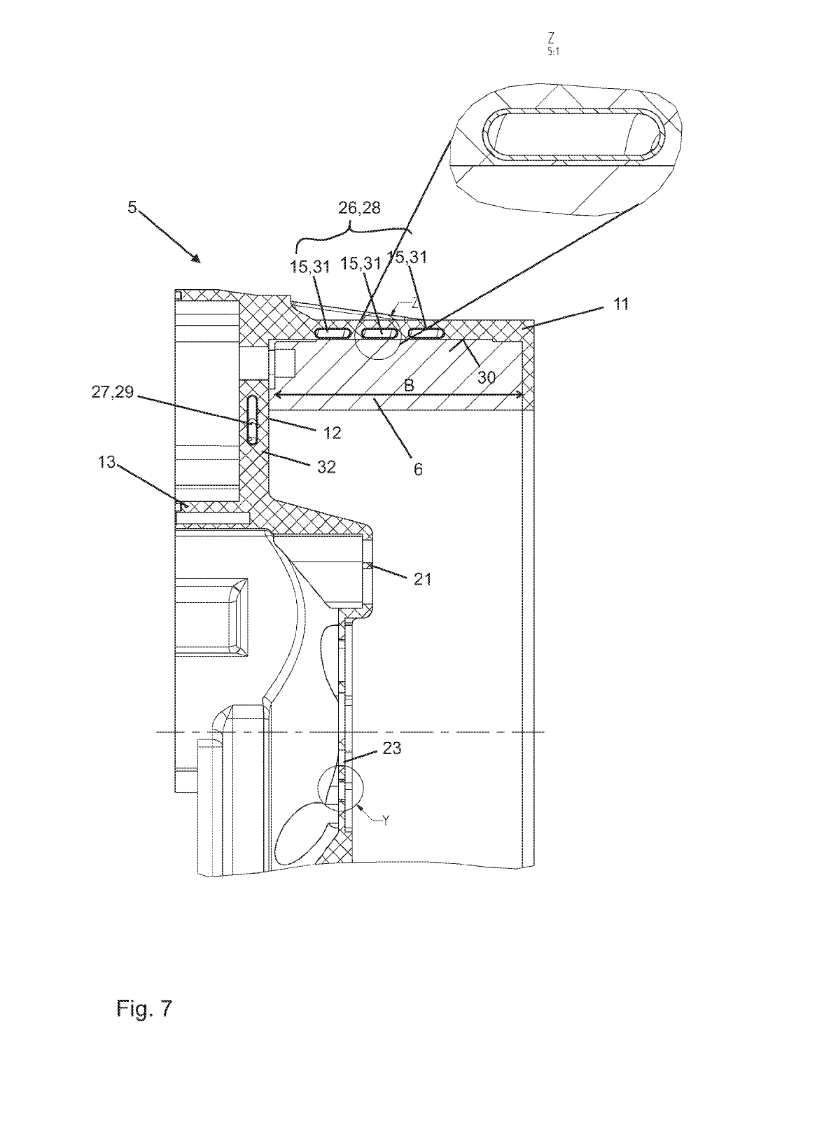

A further insert 32 in the form of a disk, for example, made of metal, is inserted in stator carrier section 12, which enables an increase of the stability of stator carrier section 12 and therefore of basic housing 5. Further insert 32 is also already embedded in the scope of the manufacturing process. A central section of the basic housing may optionally be formed as a next insert 34. Next insert 34 may be formed from metal, for example, from steel. Next insert 34 may support, for example, back plate interface 17, support point 21, or bearing interface 23. The advantage of next insert 34 as an extension of stator carrier section 12 is that in particular the attachment to wheel bearing 22 is made more rigid and more stable than in a plastic embodiment like the specific embodiment in FIG. 7. This is because of, on the one hand, the material properties of metal, in particular steel, and, on the other hand, because metal is more aging-resistant than plastic and does not have a tendency to creep.

FIG. 3 shows a three-dimensional view of cooling device 26. Cooling device 26 has cooling jacket section 28, which is formed by 3 to 4 rows of cooling coils 31, which wind around main axis of rotation 1 in particular in the form of a coiled spring or spiral. Inflow-outflow section 29, which is formed by further lines, which are laid so that the desired areas of stator carrier section 12 and/or electronics receiving section 13 are cooled, is located on the side facing toward stator carrier section 12. For example, inflow-outflow section 29 includes a cooling plate, which is located in a radial plane in relation to main axis of rotation 1 and which is designed to cool electronics. Cooling jacket section 28 forms a cylindrical interior.

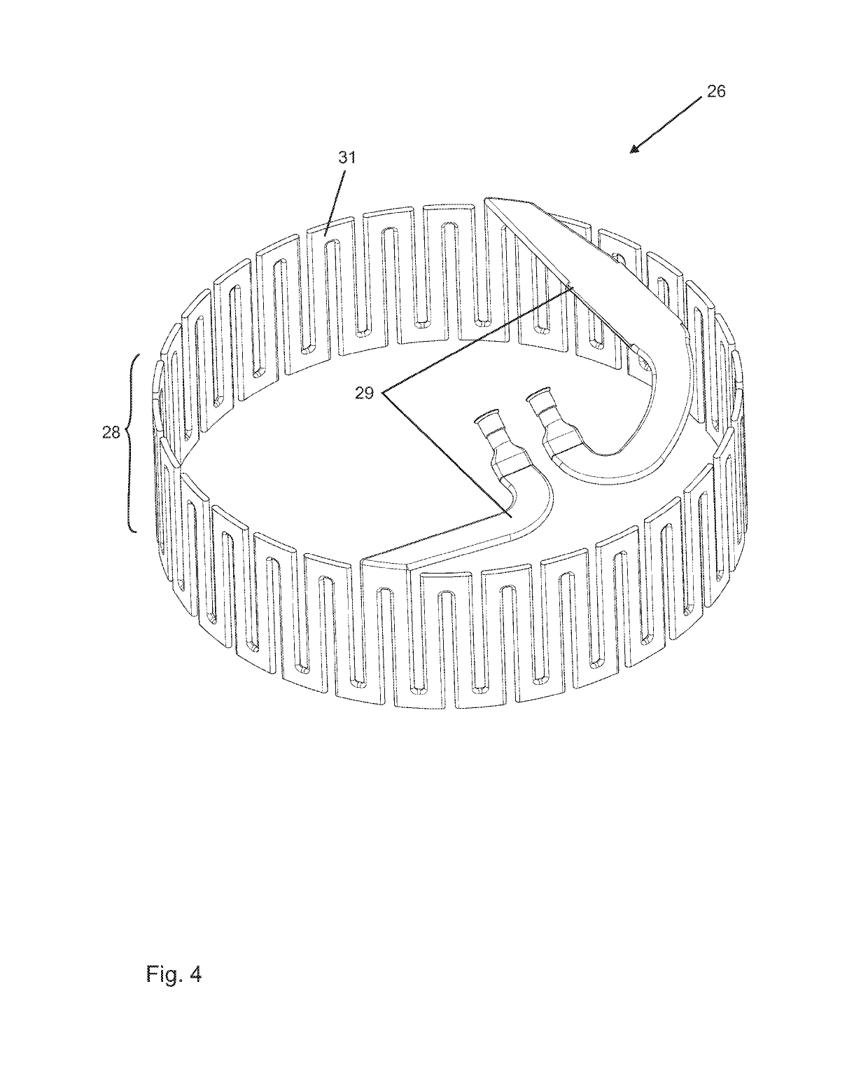

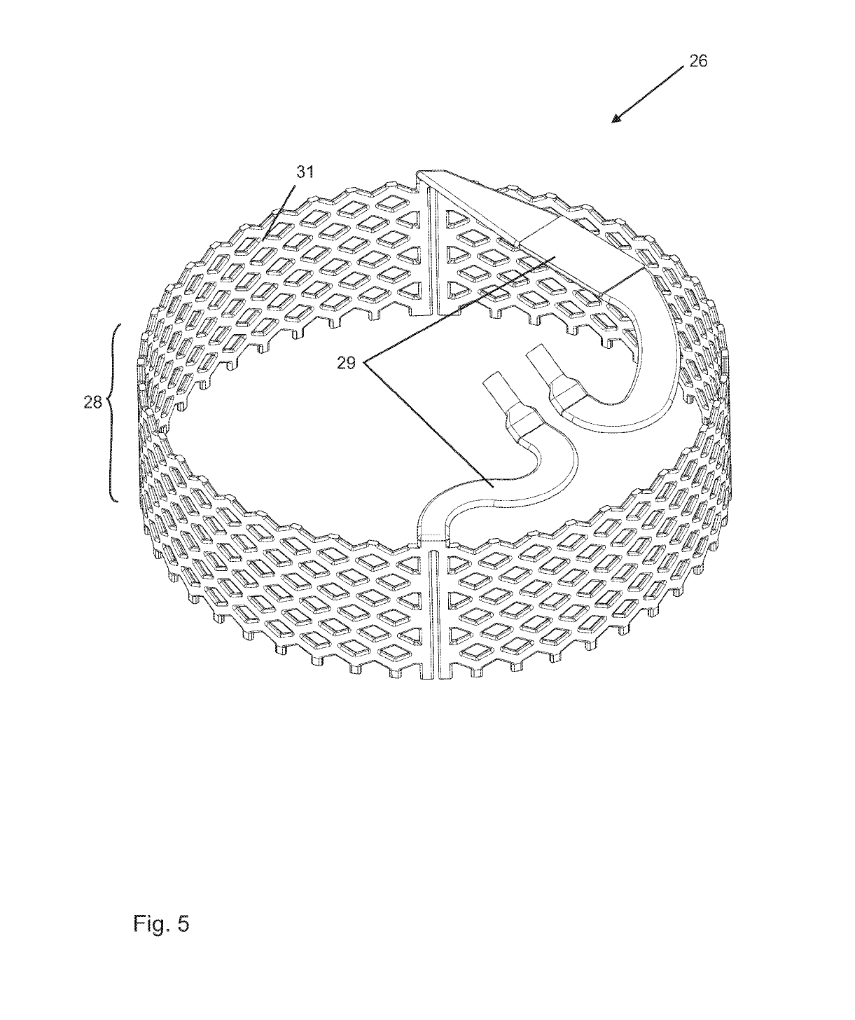

FIG. 4 shows an alternative embodiment of cooling device 26, cooling coils 31 being formed as rectangular lines, whose curvature is adapted to the curvature of contact surface 30. Cooling coils 31 each extend meandering in the axial direction in this exemplary embodiment. A structure of cooling jacket section 28 is shown in FIG. 5, cooling coils 31 being assembled into a network.

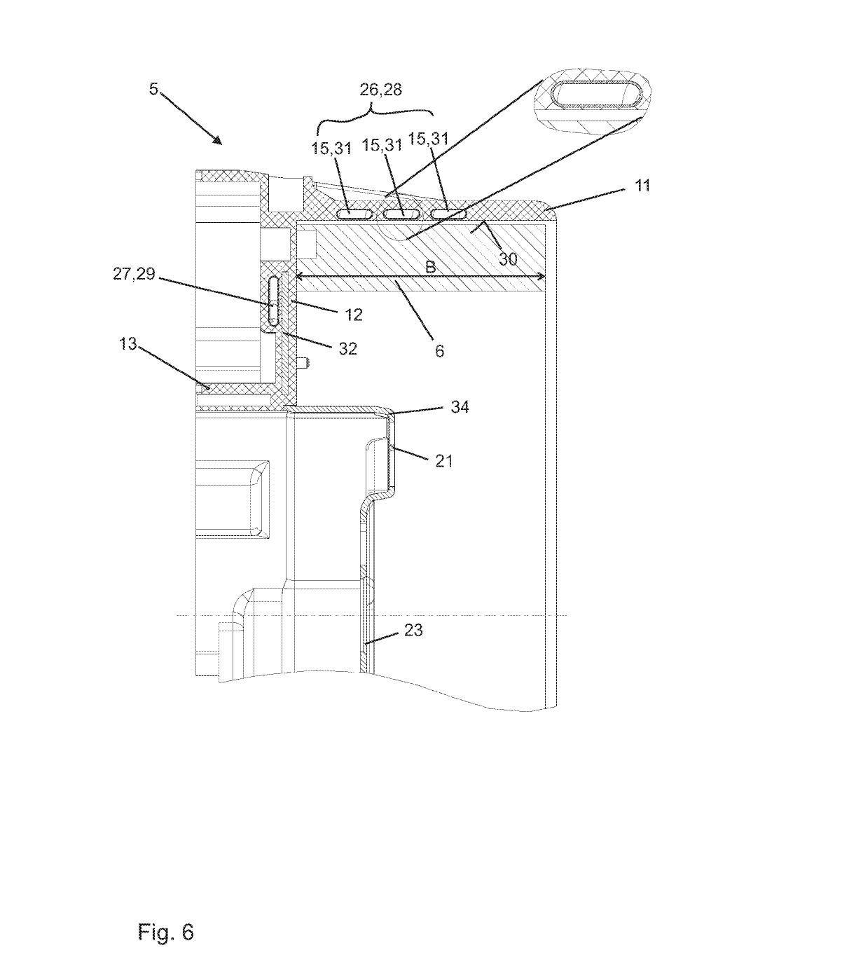

FIG. 6 shows another exemplary embodiment of the present invention, an annular gap being provided between contact surface 30 and the outer surface of stator 6. In this exemplary embodiment, stator 6 is not embedded, but rather is installed later. A liquid component or potting compound may be introduced as a temperature coupling layer into intermediate gap 33, so that the thermal transfer is optimized. Furthermore, the component or potting compound may implement a formfitting and/or friction-locked effect and mechanically secure stator 6.

FIG. 7 shows another exemplary embodiment of the present invention for a basic housing 5, in comparison to the exemplary embodiment in FIG. 2, the middle part forming a partial section of stator carrier section 12 and therefore back plate interface 17, support point 21, or bearing interface 23 being integrally formed into the plastic part. It may optionally be provided that bushings, in particular steel bushings for reinforcement, are embedded in the plastic part.

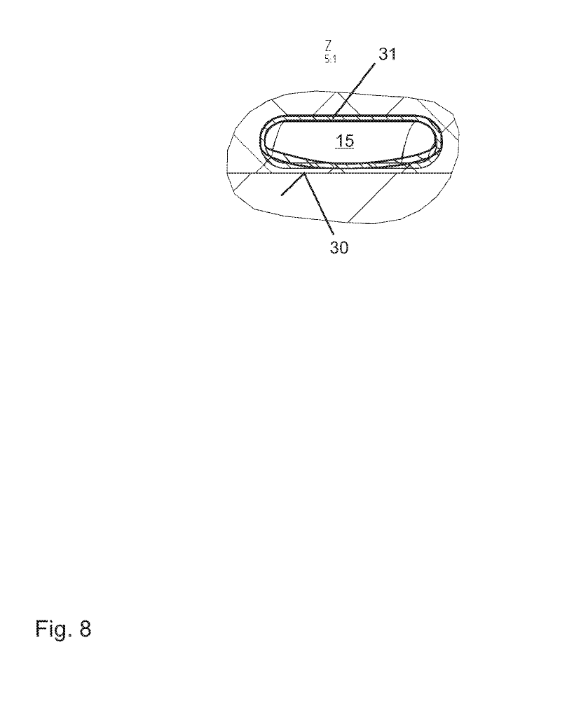

FIG. 8 shows an altered specific embodiment of the cross section of cooling coils 31, these having a conically tapering shape in the direction of contact surface 30. This conically tapering shape has the advantage that the plastic may flow better into the area between contact surface 30 and cooling coils 31.

### LIST OF REFERENCE NUMERALS

1 main axis
2 wheel hub motor
3 vehicle
4 tire
5 basic housing
6 stator
7 rotor carrier
8 rotor
9 electric motor
10 rim section
11 stator housing section
12 stator carrier section
13 electronics receiving section
14 interior
15 cooling channels
16a, b side walls
17 back plate interface
18 brake device/brake cylinder
19 brake shoes
20 brake drum
21 mechanical support point for sliding support
22 wheel bearing
23 bearing interface
24 entry and exit openings
25 circumferential, cylindrical inner wall
26 cooling device
27 cooling channel
28 cooling jacket section
29 inflow or outflow area
30 contact surface
31 cooling coils
32 further insert
33 intermediate gap
34 next insert
B width
H main axis of rotation

1-10. (canceled)

11. A basic housing for a wheel hub motor, the basic housing comprising:
a receiving area for a stator;
at least one stator housing section for situating the stator, cooling channels for cooling the stator being situated in the stator housing section;
a cooling device, the cooling device forming the cooling channels, the stator housing section being formed from a plastic and the cooling device being at least sectionally embedded in the plastic as a first insert in the stator housing section.

12. The basic housing as recited in claim 11 wherein that the stator housing section is designed as a plastic injection molded part section, the cooling device being extruded into, around or onto the plastic injection molded part section as the first insert.

13. The basic housing as recited in claim 11 wherein the cooling device has a cooling jacket section, the stator housing section having an annular wall section having a delimitation surface facing toward the stator, the cooling jacket section being situated in the annular wall section.

14. The basic housing as recited in claim 13 wherein the cooling jacket section rests exposed or open on a side facing toward the stator and forms a part of a contact surface for the stator.

15. The basic housing as recited in claim 14 wherein the cooling jacket section is designed as a cooling coil section having cooling coils, the cooling coils being flattened in a cross section through the cooling coils on the side facing toward the stator.

16. The basic housing as recited in claim 11 further comprising a stator carrier section, the stator carrier section being connected to the stator housing section and delimiting a stator receiving area formed by the stator housing section, in an axial direction, the stator carrier section being formed on the stator housing section.

17. The basic housing as recited in claim 11 further comprising an electronics receiving section for accommodating the electronics, the electronics receiving section being formed on the stator housing section or on a stator carrier section.

18. The basic housing as recited in claim 11 wherein the basic housing includes the stator, the stator being designed as a further insert embedded in the plastic.

19. The basic housing as recited in claim 11 wherein the stator housing section forms an outer housing section of the basic housing.

20. A wheel hub motor for a vehicle comprising the basic housing as recited in claim 11.
